(19) United States
(12) Patent Application Publication
(10) Pub. No.: US 2015/0044392 A1
(43) Pub. Date: Feb. 12, 2015

(54) OPTICALLY-ANISOTROPIC-LAYER-FORMING COMPOSITION

(71) Applicant: SUMITOMO CHEMICAL COMPANY, LIMITED, Tokyo (JP)

(72) Inventor: Tadahiro KOBAYASHI, Osaka-shi (JP)

(73) Assignee: SUMITOMO CHEMICAL COMPANY, LIMITED, Tokyo (JP)

(21) Appl. No.: 14/454,218

(22) Filed: Aug. 7, 2014

(30) Foreign Application Priority Data
Aug. 9, 2013 (JP) 2013-165943

(51) Int. Cl. C09K 19/38; G02B 1/12; G02B 5/30

(52) U.S. Cl. CPC C09K 19/3838; G02B 5/3016; G02B 1/12
USPC 428/1.6; 428/523; 252/299.63; 427/508

(57) ABSTRACT

Provided is an optically-anisotropic-layer-forming composition usable to make it possible to produce an optically anisotropic film high in transparency. The composition is an optically-anisotropic-layer-forming composition including a polymerizable liquid crystal compound, a photopolymerization initiator, and a solvent (1) that is a lactone solvent having a boiling point of 200° C. or higher. This composition preferably further includes a solvent (2) different from the solvent (1). The content by percentage of the solvent (1) in this composition is preferably from 1 to 70% by mass of the total of the solvents (1) and (2). The solvent (1) is preferably at least one selected from the group consisting of γ-butyrolactone, γ-valerolactone, and δ-valerolactone.

### BACKGROUND OF THE INVENTION

1. Field of the Invention

The present invention relates to an optically-anisotropic-layer-forming composition.

2. Description of the Related Art

A flat panel display device includes an optically anisotropic film such as a polarizing plate or a retardation plate. The optically anisotropic film is produced by applying an optically-anisotropic-layer-forming composition to a substrate.

International Publication WO 07/122889 describes an optically-anisotropic-layer-forming composition composed of a polymerizable liquid crystal compound, a photopolymerization initiator, and propylene glycol monomethyl ether acetate.

Optically anisotropic films each produced from a conventional optically-anisotropic-layer-forming composition may not be necessarily satisfactory in transparency.

### SUMMARY OF THE INVENTION

The present invention is as follows:
[1] An optically-anisotropic-layer-forming composition, comprising a polymerizable liquid crystal compound, a photopolymerization initiator, and a solvent (1) that is a lactone solvent having a boiling point of 200° C. or higher.
[2] The composition according to item [1], further comprising a solvent (2) different from the solvent (1).
[3] The composition according to item [2], wherein the content by percentage of the solvent (1) is from 1 to 70% by mass of the total of the solvents (1) and (2).
[4] The composition according to any one of items [1] to [3], wherein the solvent (1) is at least one selected from the group consisting of γ-butyrolactone, γ-valerolactone, and δ-valerolactone.
[5] The composition according to any one of item [1] to [4], further comprising a compound having an isocyanate group.
[6] An optically anisotropic film which is obtained by applying the composition recited in any one of items [1] to [5] onto the outer surface of an oriented film laid over a surface of a substrate, and polymerizing the polymerizable liquid crystal compound contained in the composition.
[7] A laminated body, including a substrate, an oriented film, and the optically anisotropic film recited in item [6] in the three-member described order.
[8] The laminated body according to item [7], wherein the substrate comprises a polyolefin.
[9] The laminated body according to item [7] or [8], wherein the optically anisotropic film is a retardation film.
[10] The laminated body according to any one of items [7] to [9], wherein the polymerizable liquid crystal compound is oriented vertically to the surface of the substrate.
[11] The laminated body according to any one of items [7] to [10], the rate of a change in the weight of the body being 10% or less before and after the body is heated.
[12] The laminated body according to any one of items [7] to [11], which is used for an in-plane switching (IPS) liquid crystal display device.
[13] A method for producing a laminated body, including: applying the composition recited in any one of items [1] to [5] onto the outer surface of an oriented film of an oriented-film-attached substrate, drying the resultant workpiece, and radiating light onto the dried workpiece.
[14] A polarizing plate, including the laminated body recited in any one of items [7] to [12].
[15] A display device, including the laminated body recited in any one of items [7] to [12].

According to the optically-anisotropic-layer-forming composition of the present invention, an optically anisotropic film high in transparency can be produced.

### BRIEF DESCRIPTION OF THE DRAWINGS

FIG. 1A is a schematic view illustrating an example of the polarizing plate according to the present invention;

FIG. 1B is a schematic view illustrating an example of the polarizing plate according to the present invention;

FIG. 1C is a schematic view illustrating an example of the polarizing plate according to the present invention;

FIG. 1D is a schematic view illustrating an example of the polarizing plate according to the present invention;

FIG. 1E i a schematic view illustrating an example of the polarizing plate according to the present invention;

FIG. 2A is a schematic view illustrating an example of the liquid crystal display device according to the invention; and

FIG. 2B is a schematic view illustrating an example of the liquid crystal display device according to the invention.

### DETAILED DESCRIPTION OF THE PREFERRED EMBODIMENTS

### <Optically-Anisotropic-Layer-Forming Composition>

### [Polymerizable Liquid Crystal Compound]

The polymerizable liquid crystal compound denotes a liquid crystal compound having a polymerizable group.

The above-mentioned polymerizable liquid crystal compound is, for example, a compound containing a group represented by the following formula (X) (the compound may be referred to as the compound (X) hereinafter):

P¹¹—B¹¹-E¹¹-B¹²-A¹¹-B¹³— (X)

wherein: P¹¹ represents a polymerizable group;

A¹¹ represents a bivalent alicyclic hydrocarbon group or bivalent aromatic hydrocarbon group provided that any hydrogen atom contained in the bivalent alicyclic hydrocarbon group or bivalent aromatic hydrocarbon group may be substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms may be substituted with a fluorine atom;

B¹¹ represents —O—, —S—, —CO—O—, —O—CO—, —O—CO—O—, —CO—NR¹⁶—, —NR¹⁶—CO—, —CO—, —CS— or a single bond wherein R¹⁶s each represent a hydrogen atom or an alkyl group having 1 to 6 carbon atoms (the same applies to the following R¹⁶s);

B¹² and B¹³ each independently represent —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond; and

E¹¹ represents an alkanediyl group having 1 to 12 carbon atoms provided that any hydrogen atom contained in the alkanediyl group may be substituted with an alkoxy group having 1 to 5 carbon atoms provided that any hydrogen atom contained in the alkoxy group may be substituted with a halogen atom, and provided that any —CH₂— that constitutes the alkanediyl group may be replaced with —O— or —CO—.

The number of the carbon atoms of the aromatic hydrocarbon group or alicyclic hydrocarbon group as A¹¹ is preferably from 3 to 18, more preferably from 5 to 12, in particular preferably 5 or 6. A¹¹ is preferably a cyclohexane-1,4-diyl group, or 1,4-phenylene group.

E¹¹ is preferably a linear alkanediyl group having 1 to 12 carbon atoms. Any —CH₂— that constitutes the alkanediyl group may be replaced with —O—.

Specific examples of the group include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; and —CH₂—CH₂—O—CH₂—CH₂—, —CH₂—CH₂—O—CH₂—CH₂—O—CH₂—CH₂—, and —CH₂—CH₂—O—CH₂—CH₂—O CH₂—CH₂—O—CH₂—CH₂—.

B¹¹ is preferably —O—, —S—, —CO—O—, or —O—CO—, more preferably —CO—O—.

B¹² and B¹³ are each independently preferably —O—, —S—, —C(═O)—, —C(═O)—O—, —O—C(═O)—, or —O—C(═O)—O—, more preferably —O—, or —O—C(═O)—O—.

The polymerizable group represented by P¹¹ is preferably a radical polymerizable group or cation polymerizable group since the group is high in polymerization reactivity, in particular, photopolymerization reactivity. The polymerizable group is preferably a group represented by any one of the following formulae (P-11) to (P-15) since the group is easy to handle, and the production itself of the polymerizable liquid crystal compound is also easy:

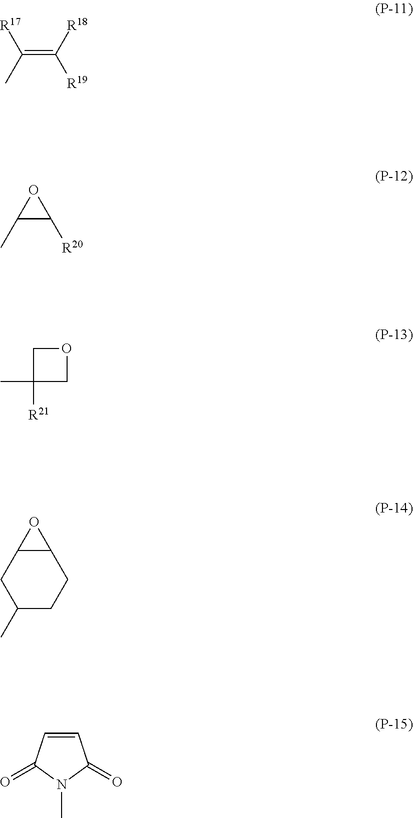

wherein R¹⁷ to R²¹ in the formulae (P-11) to (P-15) each independently represent an alkyl group having 1 to 6 carbon atoms, or a hydrogen atom.

Specific examples of the group represented by any one of the formulae (P-11) to (P-15) include respective groups represented by the following formulae (P-16) to (P-20):

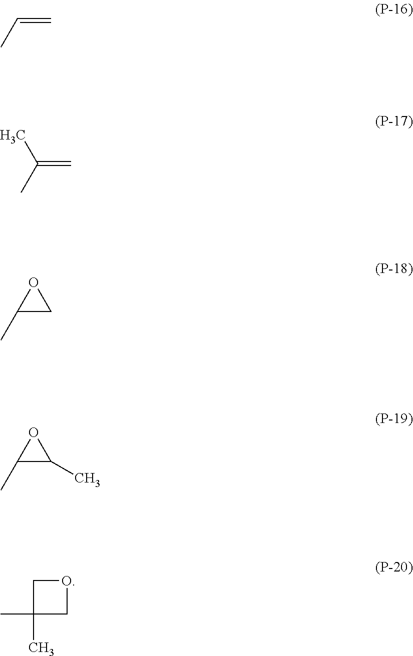

P¹¹ is preferably a group represented by any one of the formulae (P-14) to (P-20), more preferably a vinyl, p-stilbene, epoxy or oxetanyl group.

More preferably, the group represented by P¹¹—B¹¹— is an acryloyloxy or methacryloyloxy group.

Examples of the compound (X) include respective compounds represented by the following formulae (I), (II), (III), (IV), (V) and (VI):

P¹¹—B¹¹-E¹¹-B¹²-A¹¹-B¹³-A¹²-B¹⁴-A¹³-B¹⁵-A¹⁴-B¹⁶-E¹²-B¹⁷—P¹² (I),

P¹¹—B¹¹-E¹¹-B¹²-A¹¹-B¹³-A¹²-B¹⁴-A¹³-B¹⁵-A¹⁴-F¹¹ (II),

P¹¹—B¹¹-E¹¹-B¹²-A¹¹-B¹³-A¹²-B¹⁴-A¹³-B¹⁵-E¹²-B¹²—P¹² (III),

P¹¹—B¹¹-E¹¹-B¹²-A¹¹-B¹³-A¹²-B¹⁴-A¹³-F¹¹ (IV),

P¹¹—B¹²-E¹¹-B¹²-A¹¹-B¹²-A¹²-B¹⁴-E¹²-B¹⁷—P¹² (V), and

P¹¹—B¹¹-E¹¹-B¹²-A¹¹-B¹³-A¹²-F¹¹ (VI)

wherein A¹² to A¹⁴ each independently have the same meaning as A¹¹; B¹⁴ to B¹⁶ each independently have the same meaning as B¹²; B¹⁷ has the same meaning as B¹¹; E¹² has the same meaning as E¹¹; and

F¹¹ represents a hydrogen or halogen atom, or an alkyl group having 1 to 13 carbon atoms, an alkoxy group having 1 to 13 carbon atoms, a cyano, nitro, trifluoromethyl, dimethylamino, hydroxyl, methylol, formyl, sulfo (—SO₃H) or carboxyl group, or an alkoxycarbonyl group having 1 to 10 carbon atoms provided that any —CH₂— that constitutes the alkyl or alkoxy group may be replaced with —O—.

Specific examples of the polymerizable liquid crystal compound include compounds each having a polymerizable group out of compounds described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on October 30, 2000); and polymerizable liquid crystal compounds described in JP-A-2010-31223, JP-A-2010-270108, JP-A-2011-6360, and JP-A-2011-207765.

Specific examples of the compound (X) include respective compounds represented by formulae (I-1) to (I-4), formulae (II-1) to (II-4), formulae (III-1) to (III-26), formulae (IV-1) to (IV-26), formulae (V-1) to (V-2), and formulae (VI-1) to (VI-6) illustrated below. In these formulae, k1s and k2s each independently represent an integer of 2 to 12. These compounds are preferred since they can easily be synthesized or are easily available.

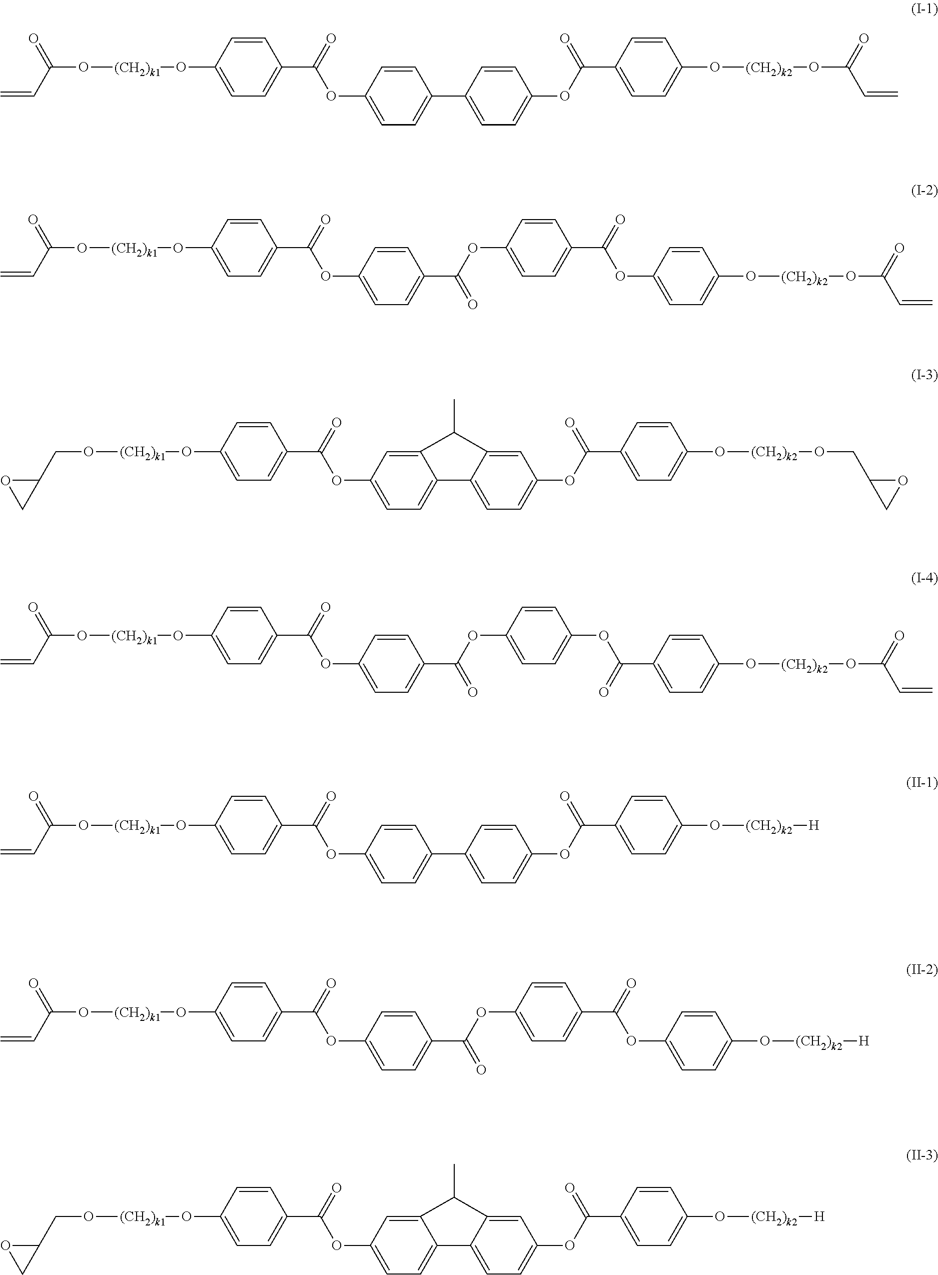

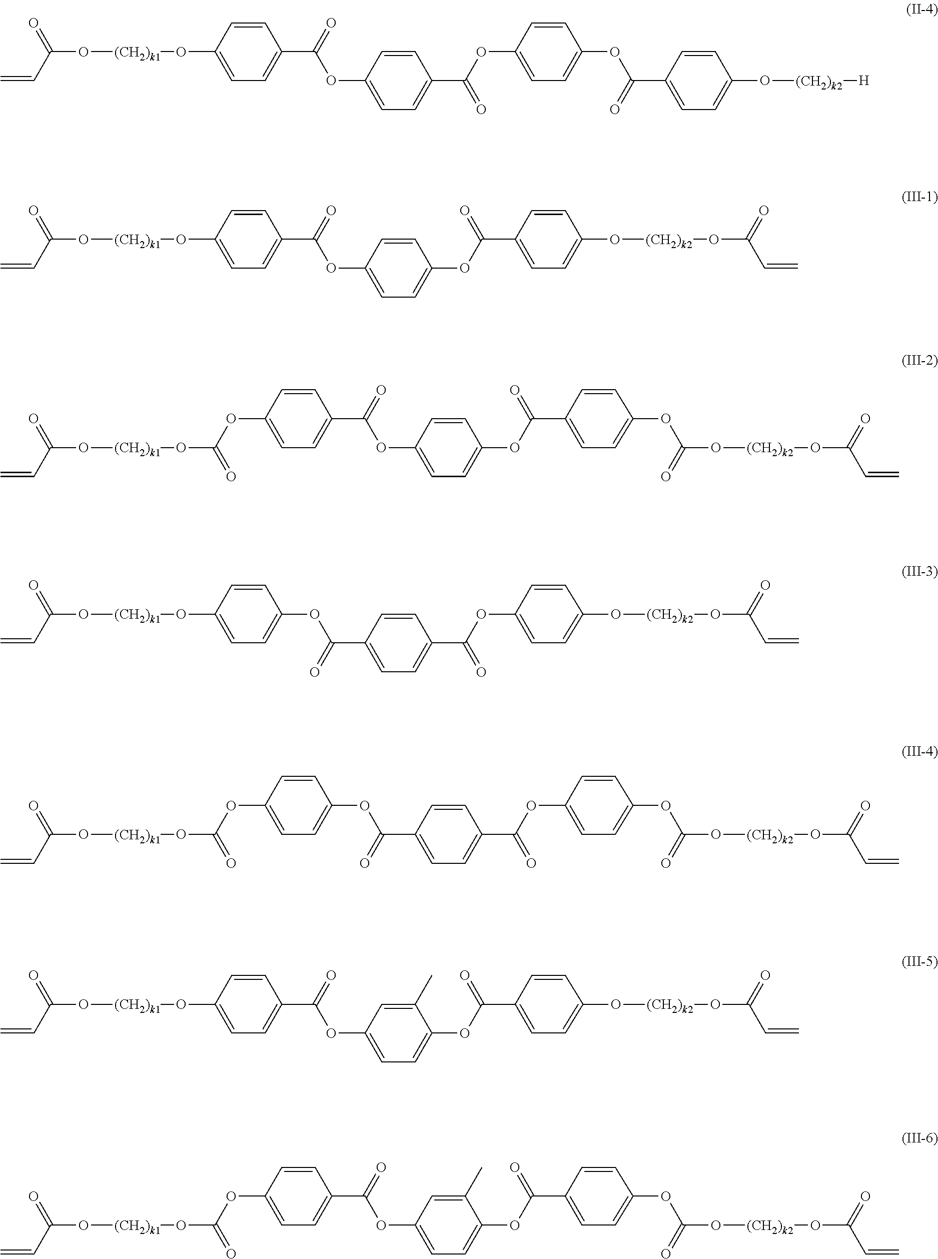

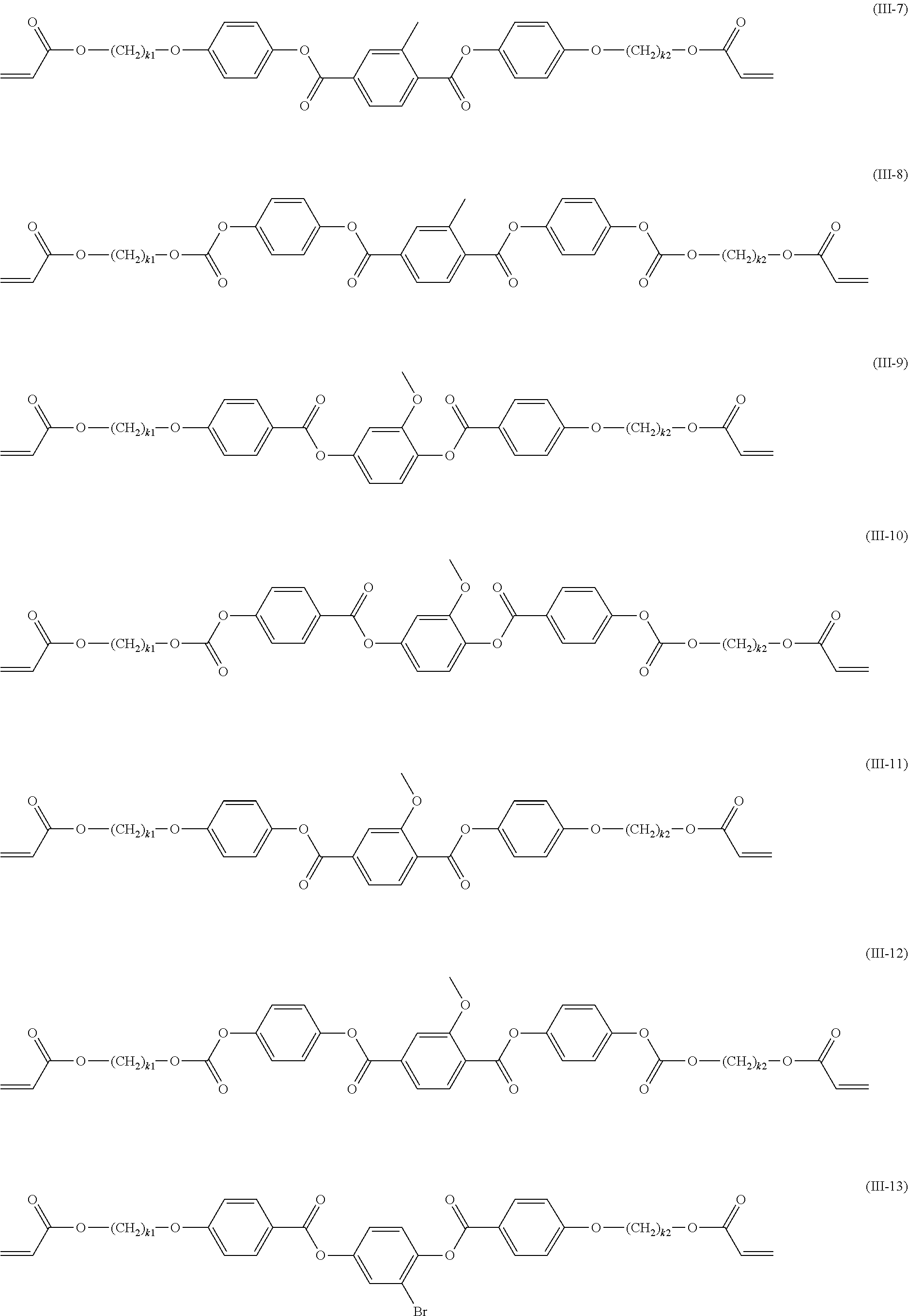

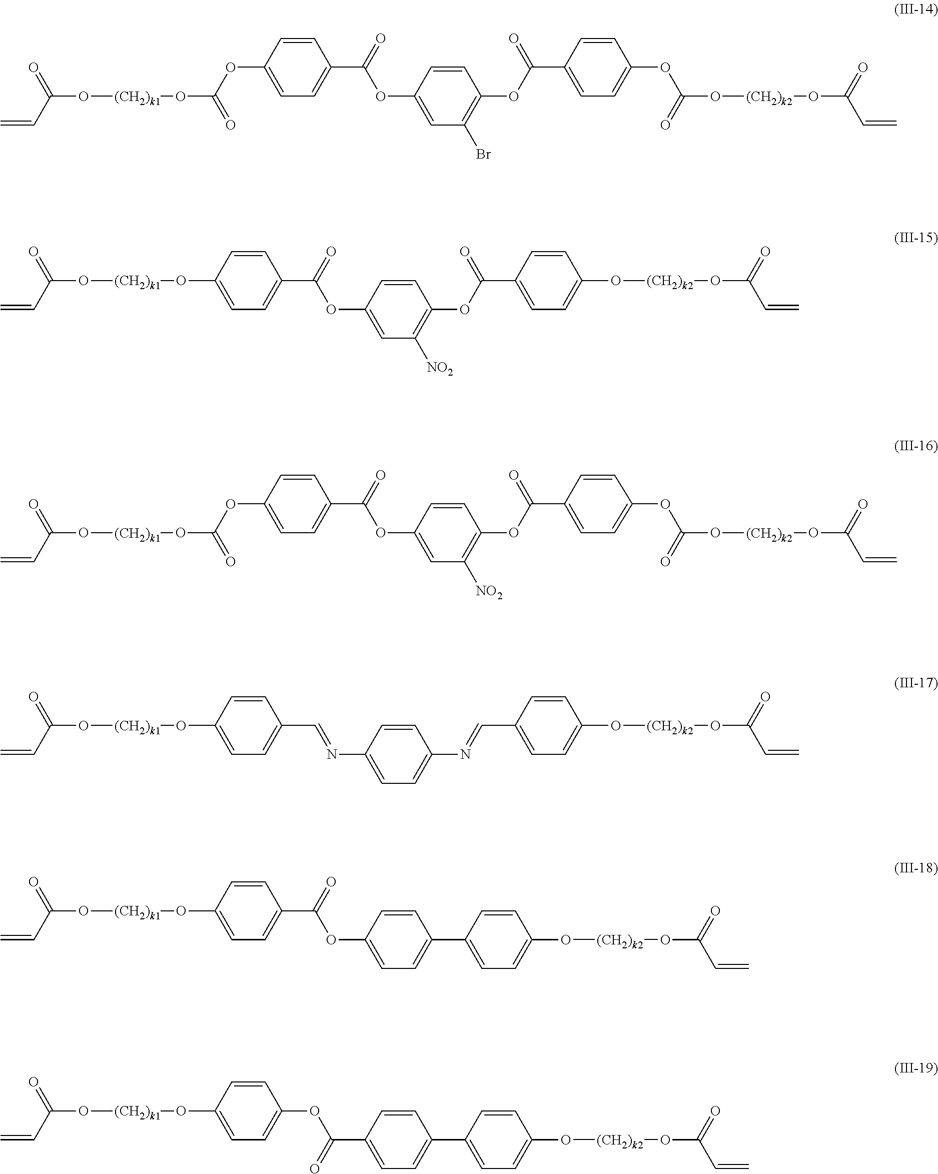

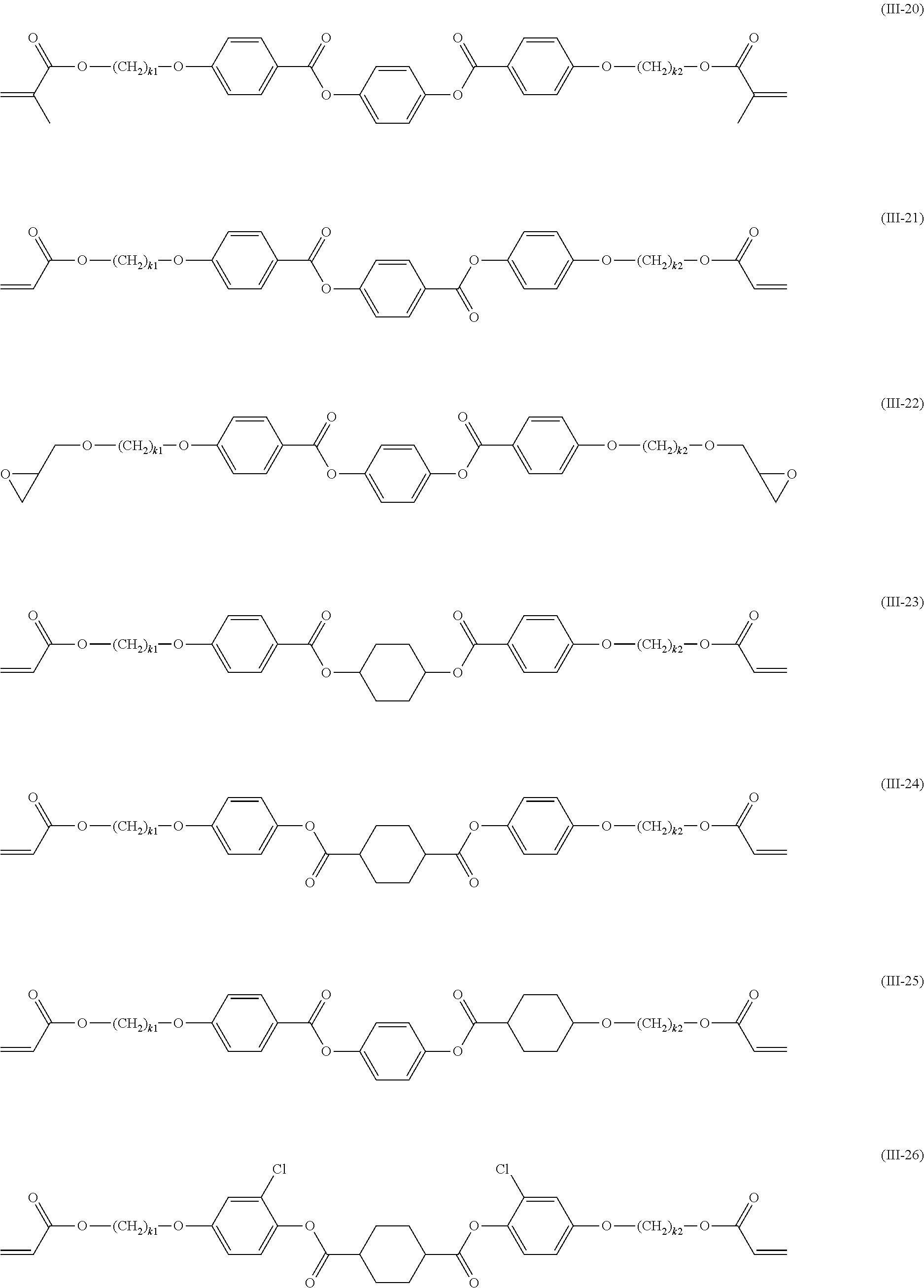

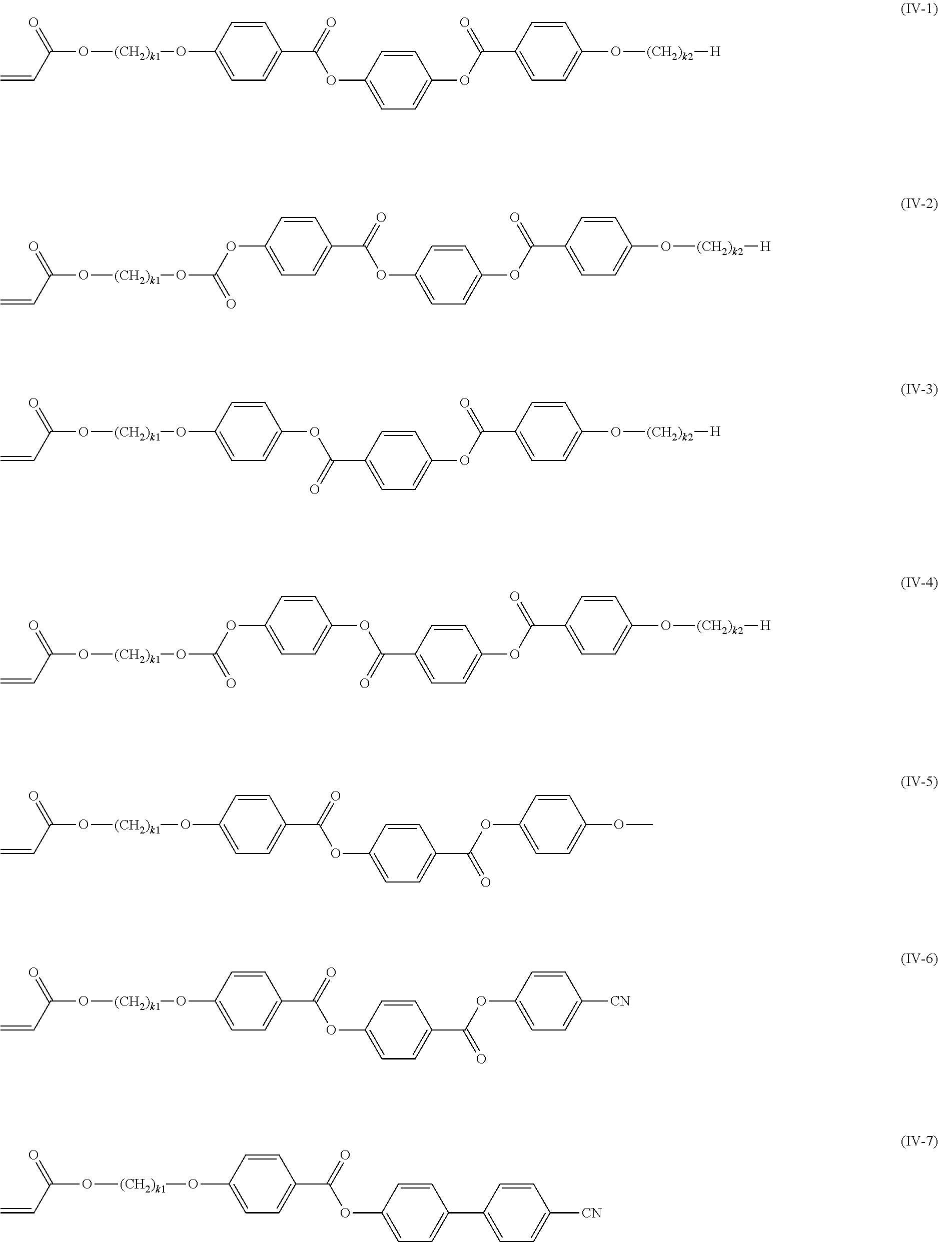

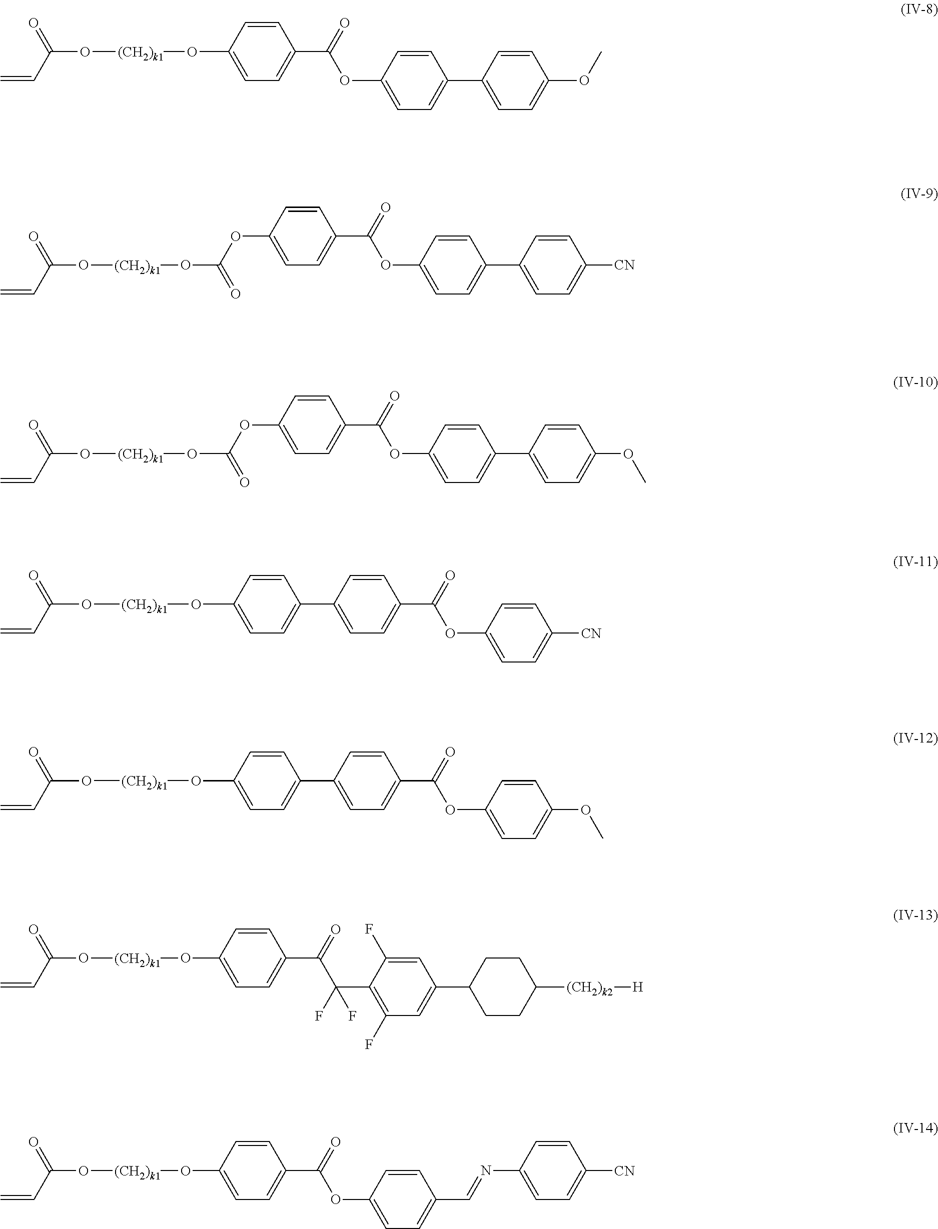

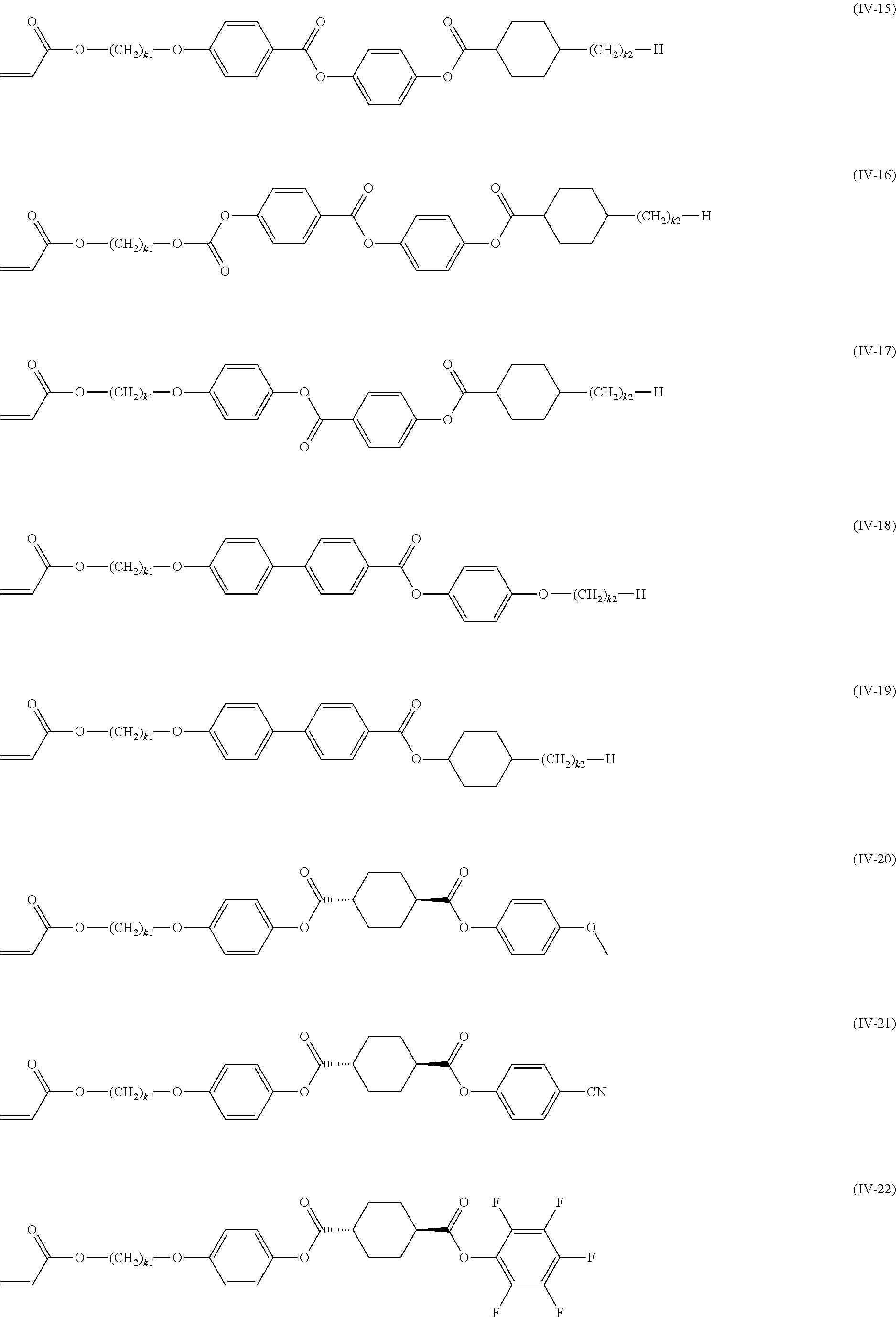

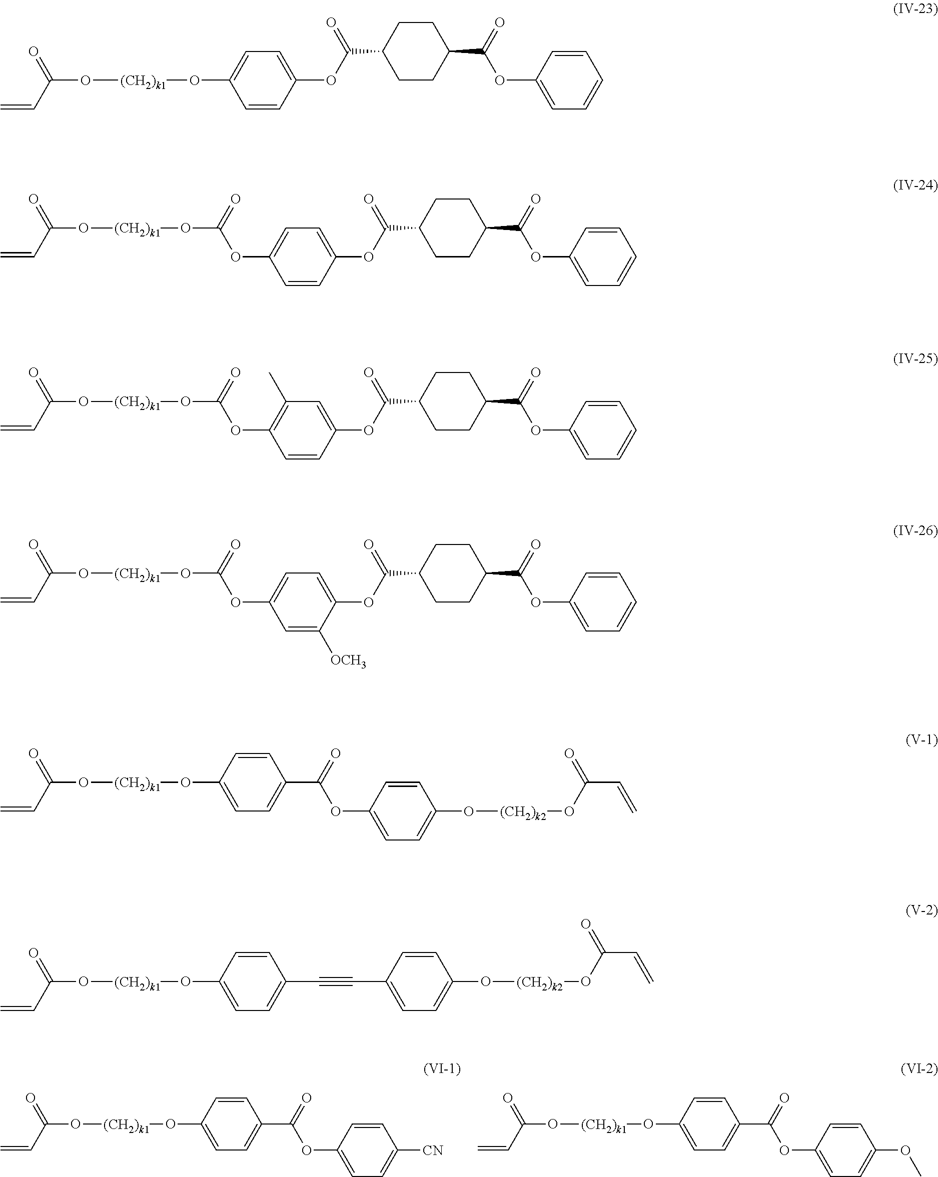

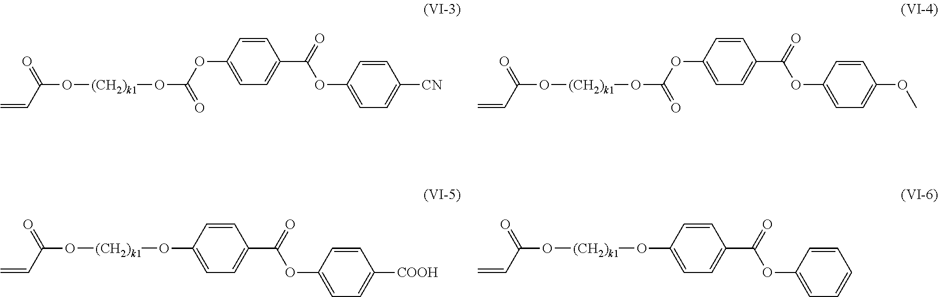

### [Photopolymerization Initiator]

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts and sulfonium salts. Specific examples thereof include products Irgacure (registered trademark) 907, 184, 651, 819, 250 and 369 (all the products are manufactured by Ciba Japan K.K.); Seikuol (registered trademark) BZ, Z, BEE (all the products are manufactured by Seiko Chemical Co., Ltd.); Kayacure (registered trademark) BP100 (manufactured by Nippon Kayaku Co., Ltd.); UVI-6992 (manufactured by the Dow Chemical Company); Adeka Optomer (registered trademark) SP-152, and SP-170 (all the products are manufactured by Adeka Corporation); TAZ-A and TAZ-PP (all the products are manufactured by Nihon Siber Hegner K.K.), and TAZ-104 (manufactured by Sanwa Chemical Co., Ltd.). Of these examples, preferred are a-acetophenone compounds. Examples of the a-acetophenone compounds include 2-methyl-2-morpholino-1-(4-methylsulfanylphenyl)propane-1-one, 2-dimethylamino-1-(4-morpholinophenyl)-2-benzylbutane-1-one, and 2-dimethylamino-1-(4-morpholinophenyl)-2-(4-methylphenylmethyl)butane-1-one. Preferred are 2-methyl-2-morpholino-1-(4-methylsulfanylphenyl)propane-1-one, and 2-dimethylamino-1-(4-morpholinophenyl) -2-benzylbutane-1-one. Commercially available product examples of the α-acetophenone compounds include products Irgacure (registered trademark) 369, 379EG, and 907 (all the products are manufactured by BASF Japan Ltd.), and Seikuol (registered trademark) BEE (manufactured by Seiko Chemical Co., Ltd.).

The content of the photopolymerization initiator in the composition is usually from 0.1 to 30 parts by mass, preferably from 0.5 to 10 parts by mass for 100 parts by mass of the polymerizable liquid crystal compound therein. When the content is in the range, the polymerizable liquid crystal compound can be polymerized without disturbing the orientation of this compound.

### [Solvent (1)]

Examples of the solvent (1) include γ-butyrolactone, γ-valerolactone, and δ-valerolactone. These solvents may be used alone or in combination. When the optically-anisotropic-layer-forming composition contains one or more of these solvents, this composition is decreased in dry unevenness when dried, and makes it possible to form an optically anisotropic film evener to be excellent in transparency.

Any boiling point and any vapor pressure in connection with the present invention are a value at one atmosphere, and a value at 23° C., respectively.

### [Solvent (2)]

Preferably, the optically-anisotropic-layer-forming composition further contains a solvent (2) different from the solvent (1).

The solvent (2) is preferably a solvent for the following purpose: when an optically anisotropic film is formed from the composition, the operability of the composition is made good. Examples thereof include organic solvents. Of the organic solvents, more preferred are solvents that are inactive to polymerization reaction of the polymerizable liquid crystal compound, and that are ones in which the polymerizable liquid crystal compound, and other constituent components of the optically-anisotropic-layer-forming composition are soluble.

The boiling point of the solvent (2) is preferably lower than 200° C., more preferably 150° C. or lower. The vapor pressure of the solvent (2) is preferably higher than 0.7 kPa.

Specific examples of the solvent (2) include alcohol solvents such as methanol, ethanol, ethylene glycol, isopropyl alcohol, propylene glycol, methylcellosolve, butylcellosolve, and phenol; ester solvents such as propylene glycol monomethyl ether acetate, ethyl acetate, and butyl acetate; ketone solvents such as acetone, methyl ethyl ketone, cyclopentanone, cyclohexanone, cycloheptanone, methyl amyl ketone, methyl isobutyl ketone, and N-methyl-2-pyrrolidone; non-chlorinated aliphatic hydrocarbon solvents such as pentane, hexane and heptane; non-chlorinated aromatic hydrocarbon solvents such as toluene, and xylene; nitrile solvents such as acetonitrile; ether solvents such as propylene glycol monomethyl ether, tetrahydrofuran, and dimethoxyethane; and chlorinated hydrocarbon solvents such as chloroform, and chlorobenzene. Such solvents may be used alone or in combination.

The solvent (2) is preferably an ester solvent having a boiling point lower than 200° C., more preferably is propylene glycol monomethyl ether acetate.

The concentration of any solid in the optically-anisotropic-layer-forming composition is preferably from 1 to 50% by mass, more preferably from 2 to 50% by mass, even more preferably from 5 to 50% by mass of the composition. The “solid” means the total of the components obtained by removing the solvent(s) from the optically-anisotropic-layer-forming composition.

The content by percentage of the solvent (1) in the total of the solvents (1) and (2) is usually from 1 to 99% by mass, preferably from 1 to 70% by mass, more preferably from 10 to 70% by mass.

### [Reactive Additive]

The optically-anisotropic-layer-forming composition of the present invention preferably contains a reactive additive. When this composition contains the reactive additive, an improvement is made in the adhesiveness between the optically anisotropic film and the oriented film in the laminated body of the present invention so that this laminated body can be restrained from undergoing a peel of its part (s) therefrom when worked.

The reactive additive is preferably a compound having in the molecule thereof a carbon-carbon unsaturated bond and an active hydrogen reactive group. The wording “active hydrogen reactive group” herein means a group reactive with a group having an active hydrogen atom, such as a carboxyl group (—COOH), hydroxyl group (—OH) or amino group (—NH₂). Typical examples thereof include glycidyl, oxazoline, carbodiimide, aziridine, imide, isocyanate, thioisocyanate, and maleic anhydride groups. The reactive additive usually has 1 to 20 carbon-carbon unsaturated bonds, and 1 to 20 active hydrogen reactive groups; and preferably has 1 to 10 carbon-carbon unsaturated bonds, and 1 to 10 active hydrogen reactive groups.

It is preferred that the reactive additive has at least two active hydrogen reactive groups. In this case, the active hydrogen reactive groups may be the same or different.

The carbon-carbon unsaturated bond that the reactive additive has may be a carbon-carbon double bond, a carbon-carbon triple bond, or a combination of the two, and is preferably a carbon-carbon double bond. It is particularly preferred that the reactive additive contains, as its carbon-carbon unsaturated bond(s), a vinyl group and/or a (meth)acrylic group. Furthermore, the reactive additive preferably has, as its active hydrogen reactive group(s), at least one selected from the group consisting of epoxy, glycidyl and isocyanate groups, and in particular preferably has an acrylic group and an isocyanate group.

Specific examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth) acrylic group and a lactone group, such as lactone acrylate and lactone methacrylate; compounds each having a vinyl group and an oxazoline group, such as vinyl oxazoline, and isopropenyl oxazoline; and oligomers each made from a compound having a (meth)acrylic group and an isocyanate group, such as isocyanatomethyl acrylate, isocyanatomethyl methacrylate, 2-isocyanatoethyl acrylate, and 2-isocyanatoethyl methacrylate. Other examples thereof include compounds each having a vinyl group or vinylene group and an acid anhydride, such as methacrylic anhydride, acrylic anhydride, maleic anhydride, and vinylmaleic anhydride. Of these examples, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the oligomers.

Specifically, a preferred example of the reactive additive is a compound represented by the following formula (Y):

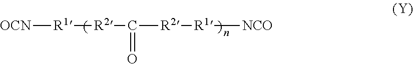

wherein n represents an integer of 1 to 10, R^{1′}s each represent a bivalent aliphatic or alicyclic hydrocarbon group having 2 to 20 carbon atoms, or a bivalent aromatic hydrocarbon group having 5 to 20 carbon atoms; and one of two R^{2′} in each of the recurring units is a group represented by —NH— and the other is a group represented by >N—C(═O)—R^{3′} wherein R^{3′} represents a hydroxyl group, or a group having a carbon-carbon unsaturated bond.

At least one of R^{3′}s in the formula (Y) is a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”):

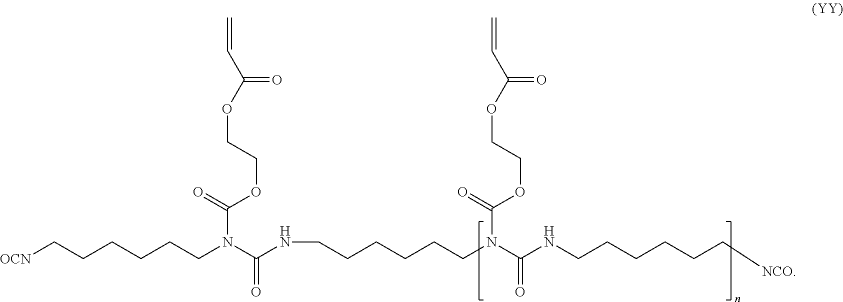

As the compound (YY), a commercially available product is usable as it is, or in the state of being purified if necessary. An example of the commercially available product is a product Laromer (registered trademark) LR-9000 (manufactured by the company BASF).

The adhesiveness between parts of the laminated body can be estimated in an adhesion test according to JIS-K 5600. It is advisable to make the adhesion test, using a commercially available device, such as a Cross-Cut Guide I Series device (CCI-1; a device for 25 squares having intervals of 1 mm) manufactured by Cotec Corporation.

In the adhesion test using, for example, this device (CCI-1), when the number of squares in each of which the optically-anisotropic-film-formed oriented film is held without being peeled from the resin substrate, out of the 25 squares, is 9 or more, that is, when the laminated body is in the state that 36% or more by area of the oriented film is not peeled from the resin substrate, the laminated body can be judged to be high in adhesiveness.

The content of the reactive additive in the optically-anisotropic-layer-forming composition is usually from 0.1 to 30 parts by mass, preferably from 0.1 to 5 parts by mass for 100 parts by mass of the polymerizable liquid crystal compound therein.

The optically-anisotropic-layer-forming composition may contain, besides the above-mentioned components, a polymerization inhibitor, a photosensitizer, a levelling agent, a chiral agent, and/or some other.

### [Polymerization Inhibitor]

The polymerization inhibitor attains the control of polymerization reaction of the polymerizable liquid crystal compound.

Examples of the polymerization inhibitor include hydroquinone and hydroquinone analogues each having, as a substituent, an alkyl ether or the like; catechol compounds each having, as a substituent, an alkyl ether or the like, such as butylcatechol; radical capturing agents such as pyrogallol compounds, and2,2,6,6-tetramethyl-1-piperidinyloxy radicals; thiophenol compounds; β-naphthylamine compounds; and β-naphthol compounds.

The content of the polymerization inhibitor in the composition is usually from 0.1 to 30 parts by mass, preferably from 0.5 to 10 parts by mass for 100 parts by mass of the polymerizable liquid crystal compound.

### [Photosensitizer]

The photosensitizer makes it possible to heighten the sensitivity of the photopolymerization initiator.

Examples of the photosensitizer include xanthone, and xanthone analogues such as thioxanthone; anthracene, and anthracene analogues such as anthracene having a substituent such as an alkylether group; phenothiazine; and rubrene.

The content of the photosensitizer in the composition is usually from 0.1 to 30 parts by mass, preferably from 0.5 to 10 parts by mass for 100 parts by mass of the polymerizable liquid crystal compound.

### [Levelling Agent]

The levelling agent makes it possible to yield a smoother optically anisotropic film, and to control the fluidity of the optically-anisotropic-layer-forming composition or adjust the crosslinkage density of the optically anisotropic film in the production process of the optically anisotropic film.

The levelling agent may be a known levelling agent, and examples thereof include organic modified silicone oil based and polyacrylate based levelling agents, and perfluoroalkyl-containing levelling agents. Specific examples thereof include products DC3PA, SH7PA, DC11PA, SH28PA, SH29PA, SH30PA, ST80PA, ST86PA, SH8400, SH8700, and FZ2123 (all the products are manufactured by Dow Corning Toray Co., Ltd.); KP321, KP323, KP324, KP326, KP340, KP341, X22-161A, and KF6001 (all the products are manufactured by Shin-Etsu Chemical Co., Ltd.); TSF400, TSF401, TSF410, TSF4300, TSF4440, TSF4445, TSF-4446, TSF4452, and TSF4460 (all the products are manufactured by Momentive Performance Materials Japan LLC); Fluorinert (registered trademark) FC-72, FC-40, FC-43, and FC-3283 (all the products are manufactured by Sumitomo 3M Limited); Megafac (registered trademark) R-08, R-30, R-90, F-410, F-411, F-443, F-445, F-470, F-477, F-479, F-482, and F-483 (all the products are manufactured by DIC Corporation); Eftop (trade name) EF301, EF303, EF351, and EF352 (all the products are manufactured by Mitsubishi Material Electronic Chemicals Co., Ltd.); Surflon (registered trademark) S-381, S-382, S-383, S-393, SC-101, SC-105, KH-40, and SA-100 (all the products are manufactured by AGC Seimi Chemical Co., Ltd.); E1830 and E5844 ((trade names) manufactured by Daikin Fine Chemical Laboratory, Ltd.); and BM-1000, BM-1100, BYK-352, BYK-353, and BYK-361N ((trade names) manufactured by a company, BM Chemie GmbH). Such levelling agents may be used in any combination of two or more thereof.

The content of the levelling agent in the composition is usually from 0.1 to 30 parts by mass, preferably from 0.1 to 10 parts by mass for 100 parts by mass of the polymerizable liquid crystal compound.

### [Chiral Agent]

The chiral agent may be a known chiral agent (for example, agents described in “Liquid Crystal Device Handbook”, Chapter 3, 4-3, Chiral Agents for TN and STN, p. 199, edited by Japan Society for the Promotion of Science, 142 Committee, 1989).

The chiral agent generally contains an asymmetric carbon atom. The chiral agent may be an axially asymmetric compound or planarly asymmetric compound, which contains no asymmetric carbon atom. Examples of the axially asymmetric compound or planarly asymmetric compound include binaphthyl, helicene, paracyclophane, and derivatives of these compounds.

Specific examples of the chiral agent include compounds as described in JP-A-2007-269639, JP-A-2007-269640, JP-A-2007-176870, JP-A-2003-137887, JP-A-2000-515496, JP-A-2007-169178, and JP-A-09-506088. The chiral agent is preferably a product Paliocolor (registered trademark) LC756 manufactured by the company BASF Japan Ltd.

The content of the chiral agent in the composition is usually from 0.1 to 30 parts by mass, preferably from 1.0 to 25 parts by mass for 100 parts by mass of the polymerizable liquid crystal compound.

### <Optically Anisotropic Film>

The optically anisotropic film of the present invention is obtained by applying the optically-anisotropic-layer-forming composition of the present invention onto a surface of an oriented film, and polymerizing the polymerizable liquid crystal compound contained in this composition.

The oriented film is usually formed over a substrate.

The substrate is usually a transparent substrate. The transparent substrate means a substrate having such a translucency that the substrate can transmit light, in particular, visible rays. Translucency denotes a property that the transmittance of any object or member for light rays having wavelengths from 380 to 780 nm is 80% or more. The transparent substrate may be specifically a glass or translucent resin substrate, and is preferably a translucent resin substrate. The substrate may be usually a substrate in the form of a film.

Examples of the resin constituting the translucent resin substrate include polyolefins such as polyethylene, polypropylene, cycloolefin polymers, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; and polyphenylene oxides. Of these examples, polyolefins such as polyethylene, polypropylene and norbornene-based polymers are preferred for the substrate.

The substrate may be subjected to surface treatment. Examples of the method for the surface treatment include a method I) of treating a surface of the substrate with corona or plasma in a vacuum or in the atmosphere; a method of treating a surface of the substrate with a laser; a method II) of treating a surface of the substrate with ozone; a method of subjecting a surface of the substrate to saponifying treatment or flame treatment; a method III) of painting a coupling agent onto a surface of the substrate to conduct primer treatment; and a graft polymerization method IV) of causing a reactive monomer or a polymer having reactivity to adhere onto a surface of the substrate, and then radiating radial rays, plasma or ultraviolet rays thereto to cause a reaction of the monomer or polymer. Of these examples, the method I) is preferred.

The method of treating a surface of the substrate with corona or plasma is, for example,

a method i) of setting the substrate between opposed electrodes under a pressure close to the atmospheric pressure, and then generating corona or plasma to treat the surface of the substrate therewith,

a method ii) of causing a gas to flow into the gap between opposed electrodes, making the gas into plasma between the electrodes, and blowing the plasma-state gas onto the surface of the substrate; or

a method iii) of generating glow discharge plasma under a low pressure to treat the surface of the substrate therewith.

Of these methods, preferred are the methods i) and ii). Usually, these surface treatments with corona or plasma can be conducted in a commercially available surface treatment apparatus.

Examples of the method for forming the oriented film onto a surface of the substrate include a method A) of applying an orienting polymer to the surface, and drying the resultant; a method B) of applying an orienting polymer to the surface, drying the resultant, and rubbing the outer surface of the applied polymer; a method C) of applying an optically orienting polymer to the surface, drying the resultant, and radiating polarized light onto the dried product; a method D) of vapor-depositing silicon oxide obliquely on the surface; and a method E) of using the Langmuir-Blodgett (LB) method to form, onto such surface, a monomolecular membrane having a long chain alkyl group. Of these methods, preferred are the methods A) and B) from the viewpoint of the evenness of the orientation of the polymerizable liquid crystal compound, and a processing period and costs for the production of the laminated body of the present invention, the production being to be detailed later.

The orienting polymer and the optically orienting polymer are each usually applied in the state of being dissolved in a solvent.

The oriented film in the present invention is preferably an oriented film which is insoluble in the optically-anisotropic-layer-forming composition; which is not deteriorated by removing the solvent (1) and other optional solvents each contained in the optically-anisotropic-layer-forming composition, or by heating for adjusting the liquid crystal orientation of the polymerizable liquid crystal compound; and which is not peeled by fraction caused when the laminated body is transported, or some other cause.

Examples of the orienting polymer include polyamides and gelatins, which each have in the molecule thereof amide bonds, polyimides, which each have in the molecule thereof imide bonds, polyamic acids, which are each a hydrolyzate of a polyimide, polyvinyl alcohol, alkyl-modified polyvinyl alcohol, polyacrylamide, polyoxazole, polyethyleneimine, polystyrene, polyvinyl pyrrolidone, polyacrylic acid, and polyacrylate. Such orienting polymers may be used alone, or in the form of a composition or copolymer made of any combination of two or more thereof. Of these examples, preferred is at least one selected from the group consisting of polyamides, polyimides, and polyamic acids. The orienting polymer can easily be produced by a polycondensation based on dehydration, deamination or the like, a chain polymerization such as radical polymerization, anion polymerization or cation polymerization, coordination polymerization, ring-opening polymerization or some other polymerization.

Examples of a commercially available product of the orienting polymer include products Sunever ((registered trademark) manufactured by Nissan Chemical Industries, Ltd.), and Optmer ((registered trademark) manufactured by JSR Corporation).

An oriented film formed by use of the orienting polymer makes the liquid crystal orientation of a polymerizable liquid crystal compound easy. In accordance with the kind of the orienting polymer or rubbing conditions therefor, the liquid crystal can be controlled into various orientations such as horizontal orientation, vertical orientation, hybrid orientation and oblique orientation. The oriented film is usable for an improvement in the visual field angle of various liquid crystal panels.

The optically orienting polymer may be a polymer having a photosensitive structure. When polarized light is radiated onto the polymer having a photosensitive structure, the photosensitive structure in the light-radiated region is isomerized or crosslinked so that the optically orienting polymer is oriented. As a result, orientation regulating force is given to a film made of the optically orienting polymer. Examples of the photosensitive structure include azobenzene, maleimide, chalcone, cinnamic acid, 1,2-vinylene, 1,2-acetylene, spiropyran, spirobenzopyran, and fulgide structures. Such optically orienting polymers may be used alone, in the form of a combination of two or more thereof, or in the form of a copolymer having different photosensitive structures. The optically orienting polymer can be produced by subjecting a monomer having a photosensitive structure to polycondensation based on dehydration or dealcoholization, a chain polymerization such as radical polymerization, anion polymerization or cation polymerization, coordination polymerization, ring-opening polymerization or some other polymerization. Examples of the optically orienting polymer include optically orienting polymers described in Japanese Patent Nos. 4450261, 4011652 and 4404090, and Japanese unexamined patent publications JP-A-2010-49230, JP-A-2007-156439 and JP-A-2007-232934. Of these examples, preferred are polymers that can each form a crosslinked structure by irradiation with polarized light from the viewpoint of the endurance thereof.

Examples of the solvent in which the orienting polymer or optically orienting polymer is soluble include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, methyl isobutyl ketone, and N-methyl-2-pyrrolidone; aliphatic hydrocarbon solvents such as pentane, hexane and heptane; aromatic hydrocarbon solvents such as toluene, xylene and chlorobenzene; nitrile solvents such as acetonitrile; ether solvents such as propylene glycol monomethyl ether, tetrahydrofuran, and dimethoxyethane; and halogenated hydrocarbon solvents such as chloroform. These solvents may be used alone or in combination.

The amount of the solvent is usually from 10 to 100000 parts by mass, preferably from 1000 to 50000 parts by mass, more preferably from 2000 to 20000 parts by mass for 100 parts by mass of the orienting polymer or optically orienting polymer.

Examples of the method for applying, to the substrate, the orienting polymer or optically orienting polymer dissolved in the solvent include extrusion coating, direct gravure coating, reverse gravure coating, CAP coating, slit coating, and die coating methods; and a method of attaining the application, using a coater such as a dip coater, a bar coater, or a spin coater.

Examples of the method for the drying include natural drying, ventilation drying, heat drying, and reduced-pressure drying; and any combination of two or more of these methods. The drying temperature is preferably from 10 to 250° C., more preferably from 25 to 200° C. The drying period, which depends on the kind of the solvent, is preferably from 5 seconds to 60 minutes, more preferably from 10 seconds to 30 minutes.

The method for the rubbing may be a method of bringing a rubbing-cloth-wound rubbing roll that is being rotated into contact with the orienting polymer applied to the substrate and then dried.

The method for radiating the polarized light is, for example, a method by use of a device described in JP-A-2006-323060. A patterned oriented film can be formed by radiating polarized light, such as linearly polarized ultraviolet rays, onto a desired region (composed of plural sections) through a photomask corresponding to the desired region, and repeating this operation also for each of other desired regions. The photomask may be usually a member in which a light-shielding pattern is located onto a piece or film made of quartz glass, soda-lime glass, polyester or some other material. The region covered with the light-shielding pattern shuts out the radiated polarized light while the region uncovered therewith transmits the radiated polarized light. The quartz glass piece is preferred since the effect of thermal expansion to the piece is small. The radiated polarized light is preferably ultraviolet rays from the viewpoint of the reactivity of the optically orienting polymer with the rays.

The thickness of the oriented film is usually from 10 to 10000 nm, preferably from 10 to 1000 nm.

When the thickness of the oriented film is in the range, the polymerizable liquid crystal compound can be favorably liquid-crystal oriented with ease into a desired direction or angle.

An optically anisotropic film is obtained by applying the optically-anisotropic-layer-forming composition onto a surface of the oriented film and polymerizing the polymerizable liquid crystal compound contained in the optically-anisotropic-layer-forming composition, or attaining the same application and then drying the resultant to polymerize the polymerizable liquid crystal compound contained in the optically-anisotropic-layer-forming composition. When the optically anisotropic film shows a liquid crystal phase such as a nematic phase, the film has birefringence based on mono-domain orientation. The optically anisotropic film of the present invention is not easily affected by a change in the birefringence on the basis of heat since the liquid crystal orientation of the polymerizable liquid crystal compound is fixed.

The thickness of the optically anisotropic film is appropriately adjustable in accordance with the usage thereof, and is preferably from 0.1 to 10 μm, more preferably from 0.2 to 5 μm in order to make this film small in photoelasticity.

Examples of the optically anisotropic film include a retardation film, and a polarization film.

The retardation film can be obtained by orienting the polymerizable liquid crystal compound vertically or horizontally and polymerizing the compound. Such a wording as “vertical orientation” (of any polymerizable liquid crystal compound) denotes that the polymerizable liquid crystal compound has a long axis thereof vertically to the plane of the substrate. Such a wording as “horizontal orientation” thereof denotes that the polymerizable liquid crystal compound has a long axis thereof in parallel with the plane of the substrate.

The liquid crystal orientation of the polymerizable liquid crystal compound is controlled by respective properties of the oriented film and the polymerizable liquid crystal compound. For attaining vertical orientation, it is preferred to select a polymerizable liquid crystal compound that is vertically oriented with ease, and an oriented film that causes this polymerizable liquid crystal compound to be vertically oriented.

When the oriented film is made of, for example, a material having an orientation regulating force expressing horizontal orientation, the polymerizable liquid crystal compound can attain horizontal orientation or hybrid orientation. When the oriented film is made of a material having an orientation regulating force expressing vertical orientation, the polymerizable liquid crystal compound can attain vertical orientation or oblique orientation.

When the oriented film is made of, for example, an orienting polymer, the orientation regulating force is adjustable at will in accordance with the surface state, or rubbing conditions. When the oriented film is made of an optically orienting polymer, the force is adjustable at will in accordance with polarized-light-radiating conditions and others. The liquid crystal orientation of the polymerizable liquid crystal compound is also controllable by selecting the surface tension, the liquid crystal property or some other property of this compound.

Examples of the method for applying the optically-anisotropic-layer-forming composition onto the oriented film include extrusion coating, direct gravure coating, reverse gravure coating, CAP coating, slit coating, and die coating methods; and a method of attaining the application, using a coater such as a dip coater, a bar coater, or a spin coater. Preferred are CAP coating, inkjet coating, dip coating, slit coating, die coating, and bar-coater-used coating methods since these methods make it possible to attain the application continuously in a roll-to-roll manner. When the roll-to-roll manner is employed, it is possible to apply an orienting polymer or optically orienting polymer onto a substrate to form an oriented film, and continuously form an optically anisotropic film onto the resultant oriented film.

Examples of the method for the drying include the same drying methods as used for the formation of the oriented film. Of these methods, preferred are natural drying and heat drying. The drying temperature is usually from 0 to 250° C., preferably from 50 to 220° C., more preferably from 80 to 170° C. The drying period is usually from 10 seconds to 60 minutes, preferably from 30 seconds to 30 minutes.

The method for polymerizing the polymerizable liquid crystal compound is preferably photopolymerization. The photopolymerization makes it possible to polymerize this compound at a low temperature. Thus, this method is preferred from the viewpoint of the heat resistance of the substrate. Reaction for the photopolymerization is usually conducted by irradiation with visible rays, ultraviolet rays or a laser, preferably with ultraviolet rays.

The irradiation with the light is performed preferably after the solvent(s) contained in the applied optically-anisotropic-layer-forming composition is dried to be removed. The drying may be performed simultaneously with the irradiation with the light. Preferably, before the irradiation with the light is performed, almost all of the solvent(s) should be removed.

When the oriented film is formed over the substrate, the formation of an optically anisotropic film onto the outer surface of the oriented film makes it possible to yield a laminated body having the substrate, the oriented film and the optically anisotropic film in this order. The laminated body of the present invention is excellent in transparency in the visible ray range to be useful as various members for display devices.

About the laminated body, the rate of a change in the weight thereof is usually 20% or less, preferably 15% or less, more preferably 10% or less, even more preferably 1% or less before and after the laminated body is heated. The heating temperature is not limited as far as the temperature is a temperature which does not cause the substrate to be thermally deformed. It is sufficient for the temperature to be from 100 to 120° C. It is sufficient for the heating period to be a period when it can be checked whether or not the solvent and other volatile components are present. The period is, for example, from 30 seconds to 2 minutes. About the laminated body obtained according to the present invention, a product obtained therefrom tends to be favorably improved in endurance since the solvent has been removed and the amount of the remaining volatile components is small.

The haze value of the laminated body is usually 0.8% or less, preferably 0.5% or less, more preferably 0.3% or less, even more preferably 0.2% or less.

A product obtained by laminating laminated bodies of the present invention onto each other, or combining the laminated body of the invention with a different film is usable as a viewing angle compensating film, a viewing angle enlarging film, an antireflective film, a polarizing plate, a circularly polarizing plate, an elliptically polarizing plate, or a brightness enhancement film.

The laminated body in which its optically anisotropic film is a retardation film is particularly useful as an optical material for converting, into circularly polarized light or elliptically polarized light, polarized light considered to be linearly polarized light when the polarized light is checked from any oblique angle at the light-radiating-out side of the body; for converting polarized light considered to be circularly or elliptically polarized light into linearly polarized light; or for changing the polarization direction of linearly polarized light.

The laminated body in which its optically anisotropic film is a retardation film can be changed in optical property in accordance with the orientation state of the polymerizable liquid crystal compound, which forms the optically anisotropic film. The laminated body is usable as a retardation plate for a liquid crystal display device that may be in various modes such as a vertical alignment (VA) mode, an in-plane switching (IPS) mode, an optically compensated bend (OCB) mode, a twisted nematic (TN) mode, and a super twisted nematic (STN) mode. The laminated body is preferably used particularly for an IPS mode liquid crystal display device.

When the refractive index of the laminated body in the in-plane slow axis direction thereof is represented by nₓ, that in the direction orthogonal to the in-plane slow axis (i.e., the fast axis direction) by n_{y}, and that in the thickness direction thereof by n_{z}, the laminated body of the present invention can be classified as follows:

a positive A plate in which nₓ>n_{y}≅n_{z},

a negative C plate in which nₓ≅n_{y}>n_{z},

a positive C plate in which nₓ≅n_{y}<n_{z}, and

a positive O plate and a negative O plate in which nₓ≠n_{y}≠n_{z}.

It is advisable to select the retardation value of the laminated body in which its optically anisotropic film is a retardation film from the range of 30 to 300 nm appropriately in accordance with a display device in which the laminated body is used.

When the laminated body is used as a positive C plate, it is advisable to adjust the front retardation value Re (549) into the range of 0 to 10 nm, preferably into that of 0 to 5 nm, and adjust the thickness direction retardation value Rₜₕ into the range of −10 to −300 nm, preferably into that of −20 to −200 nm. It is particularly preferred to adjust these values in accordance with properties of the liquid crystal cell.

The thickness direction retardation value Rₜₕ, which means the refractive index anisotropy of the laminated body in the thickness direction, can be calculated from the retardation value R₄₀ measured in the state of inclining the in-plane fast axis of the body at 40 degrees to be rendered an inclined axis, and the in-plane retardation value R₀. Specifically, the thickness direction retardation value Rₜₕ can be calculated by: using plural values (i.e., the in-plane retardation value R₀, the retardation value R₄₀, which is measured in the state of inclining the fast axis at 40 degrees to be rendered an inclined axis, the retardation film thickness d, and the average refractive index n₀ of the retardation film) to calculate the refractive indexes nₓ, n_{y} and n_{z} through equations (9) to (11) described below; and then substituting these refractive indexes for an equation (8) described below.

Rₜₕ=[(nₓ+n_{y})/2−n_{z}]×d (8),

R₀=(nₓ−n_{y})×d (9),

R₄₀=(nₓ−n_{y}′)×d/cos(φ) (10), and

(nₓ+n_{y}+n_{z})/3=n₀ (11)

wherein φ=sin⁻¹ [sin(40°)/n₀], and

n_{y}′=n_{y}×n_{z}/[n_{y}²×sin²(φ)+n_{z}²×cos²(φ)]^{1/2}.

The laminated body of the present invention is useful also as a member constituting a polarizing plate.

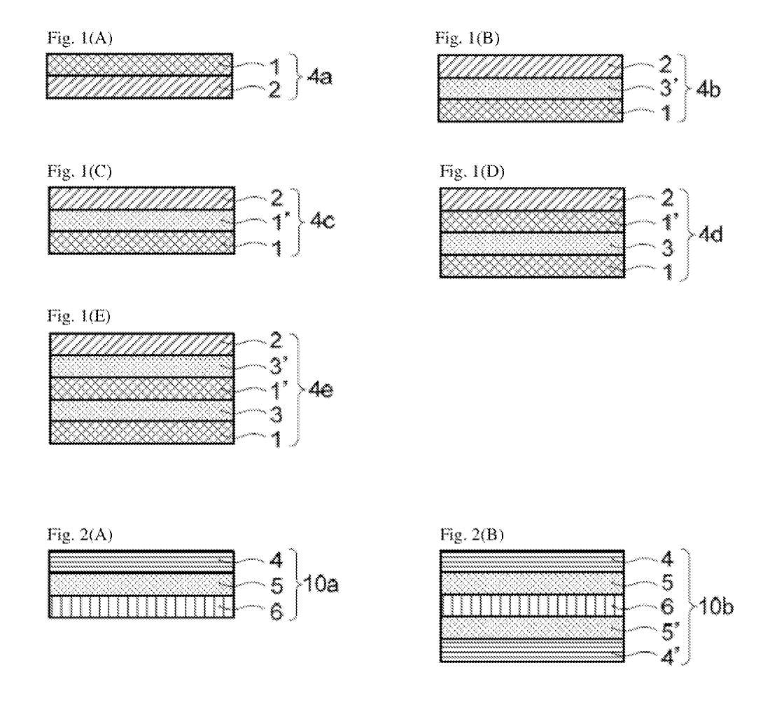

Specific examples of the polarizing plate include respective polarizing plates 4a to 4e illustrated in FIGS. 1A to 1E. The polarizing plate 4a illustrated in FIG. 1A is a polarizing plate in which a retardation film 1 and a polarization film 2 are laminated directly onto each other. The polarizing plate 4b illustrated in FIG. 1B is a polarizing plate in which a retardation film 1 and a polarization film 2 are bonded onto each other through an adhesive layer 3′. The polarizing plate 4c illustrated in FIG. 1C is a polarizing plate in which retardation films 1 and 1′ are laminated onto each other and further a polarization film 2 is laminated onto the retardation film 1′. The polarizing plate 4d illustrated in FIG. 1D is a polarizing plate in which retardation films 1 and 1′ are bonded onto each other through an adhesive layer 3, and further a polarization film 2 is laminated onto the retardation film 1′. The polarizing plate 4e illustrated in FIG. 1E is a polarizing plate in which retardation films 1 and 1′ are bonded onto each other through an adhesive layer 3, and further the retardation film 1′ and a polarization film 2 are bonded onto each other through an adhesive layer 3′. The wording “adhesive” is a generic name of any adhesive and/or any binder.

The laminated body of the present invention in which its optically anisotropic film is a retardation film is usable as each of the retardation films 1 and 1′. The laminated body of the present invention in which its optically anisotropic film is a polarization film is usable as each of the polarization films 2.

It is sufficient for the individual polarization films 2 to be each a film having a polarizing function. Besides the laminated body of the present invention, the following is usable therefor: for example, a film obtained by causing iodine or a dichroic dye to be adsorbed to a polyvinyl alcohol based film, and then drawing the resultant film; or a film obtained by drawing a polyvinyl alcohol based film, and then causing iodine or a dichroic dye to be adsorbed to the drawn film.

The polarization film 2 may be protected with a protective film if necessary. Examples of the protective film include polyolefin films, examples of the polyolefin including polyethylene, polypropylene and norbornene polymers; and polyethylene terephthalate, polymethacrylate, polyacrylate, cellulose ester, polyethylene naphthalate, polycarbonate, polysulfone, polyethersulfone, polyetherketone, polyphenylenesulfide, and polyphenyleneoxide films.

The adhesive that forms the adhesive layers 3 and 3′ is preferably an adhesive high in transparency and excellent in heat resistance. Examples of the adhesive include acrylic based, epoxy based and urethane based adhesives.

The optically anisotropic film of the present invention is usable for a display device. Examples of the display device include a liquid crystal display device having a liquid crystal panel in which the laminated body of the invention and a liquid crystal panel body are bonded to each other; and an organic electroluminescence (also abbreviated to EL hereinafter) display device having an organic EL panel in which the laminated body of the invention and a luminous layer are bonded to each other. Hereinafter, a description will be made about liquid crystal display devices as embodiments of a display device having the laminated body of the invention.

In embodiments, the liquid crystal display devices are shown as liquid crystal display devices 10a and 10b illustrated in FIGS. 2A and 2B, respectively. In the liquid crystal display device 10a illustrated in FIG. 2A, a polarizing plate 4 of the present invention and a liquid crystal panel 6 are bonded through an adhesive layer 5. In the liquid crystal display device 10b illustrated in FIG. 2B, a polarizing plate 4 of the present invention is bonded to one of the two main surfaces of a liquid crystal panel 6 through an adhesive layer 5 while a polarizing plate 4′ of the invention is bonded to the other main surface of the liquid crystal panel 6 through an adhesive layer 5′. Electrodes not illustrated are used in these liquid crystal display devices to apply a voltage to their liquid crystal panel to change the orientation of molecules of their liquid crystal. In this way, a monochrome display can be realized.

### EXAMPLES

Hereinafter, the present invention will be more specifically described by way of working examples thereof. In the examples, the symbol “%” and the word “part(s)” denote “% by mass” and “part(s) by mass”, respectively, unless otherwise specified.

### [Oriented-Film-Forming Composition]

Individual components shown in Table 1 were mixed with each other to yield an oriented-film-forming composition (1).

The proportion of the amount of each of the components of the oriented-film-forming composition is represented by a numerical value inside the parentheses in Table 1. The proportion of any solid in the orienting polymer has been converted from the polymer concentration described in a delivered specification of the polymer.

TABLE 1

| | Orienting polymer: | | |
|---|---|---|---|
| | Sunever ((registered | | |
| | trademark) SE-610, | | |
| | manufactured by | | |
| | Nissan Chemical | | |
| | Industries, Ltd.) | N-methyl-2-pyrrolidone | Butylcellosolve |
| (1) | 0.16 g (0.6%) | 20.0 g (79.5%) | 5.0 g (19.9%) |

### [Optically-Anisotropic-Layer-Forming Composition]

Individual components shown in Table 2 were mixed with each other, and the resultant solution was stirred at 80° C. for 1 hour. The solution was then cooled to room temperature to yield an optically-anisotropic-layer-forming compositions (1) to (3) and (H1).

TABLE 2

| | Polymerizable | | | | | |
|---|---|---|---|---|---|---|
| | liquid crystal | Photopolymerization | Levelling | | | |
| | compound | initiator | agent | Additive | Solvent 2 | Solvent 1 |
| (1) | 19.2 | 0.6 | 0.1 | 1.1 | 63.2 | 1-1:15.8 |
| (2) | 19.2 | 0.6 | 0.1 | 1.1 | 63.2 | 1-2:15.8 |
| (3) | 19.2 | 0.6 | 0.1 | 1.1 | 63.2 | 1-3:15.8 |
| (H1) | 19.2 | 0.6 | 0.1 | 1.1 | 79 | 0 |

Unit in Table 2: % (the proportion of each of the components in the optically-anisotropic-layer-forming composition)

Polymerizable liquid crystal compound: polymerizable liquid crystal compound produced by a method described in JP-A-2010-001284 and represented by the following formula:

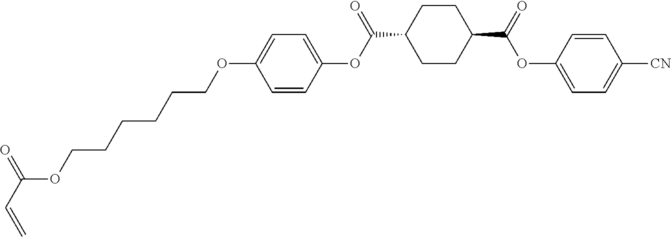 [SMILES: C=CC(=O)OCCCCCCOc1ccc(OC(=O)[C@H]2CC[C@H](C(=O)Oc3ccc(C#N)cc3)CC2)cc1]

Photopolymerization initiator: Irgacure (registered trademark) 369 ((trade name) manufactured by BASF Japan Ltd.)

Levelling agent: BYK-361N ((trade name) manufactured by BYK-Chemie Japan K.K.)

Additive: Laromer (registered trademark) LR-9000 (manufactured by BASF)

Solvent 2: propylene glycol monomethyl ether acetate

Solvent 1:
Solvent 1-1: γ-butyrolactone (boiling point: 204° C.)
Solvent 1-2: γ-valerolactone (boiling point: 207° C.)
Solvent 1-3: γ-valerolactone (boiling point: 220° C.)

### Example 1

A surface of a cycloolefin polymer film (Zeonor (registered trademark) manufactured by Zeon Corporation) was subjected to corona treatment one time by use of a corona treatment machine (AGF-B10, manufactured by Kasuga Electric Works Ltd.) at a power of 0.3 kW and a treating speed of 3 m/min.

The oriented-film-forming composition (1) was applied onto the corona-treated surface. The workpiece was dried to form an oriented film having a thickness of 45 nm. A bar coater was used to apply the optically-anisotropic-layer-forming composition (1) onto the outer surface of the oriented film. The workpiece was heated to 110° C. to form a non-polymerized film on the oriented film. The workpiece was cooled to room temperature, and then a device, Unicure (VB-15201BY-A, manufactured by Ushio Inc.) was used to radiate ultraviolet rays onto the workpiece for 30 seconds so as to give an illuminance of 40 mW/cm² at a wavelength of 365 nm. In this way, a laminated body (1) was yielded.

### Examples 2 and 3, and Comparative Example 1

Laminated bodies (2), (3), and (H1) were produced in the same way as in Example 1 except that the optically-anisotropic-layer-forming composition (1) was changed to the optically-anisotropic-layer-forming compositions (2), (3), and (H1), respectively.

### [Transparency Evaluation]

A haze meter (model: HZ-2) manufactured by Suga Test Instruments Co., Ltd. was used to measure the respective haze values of the laminated bodies (1) to (3) and (H1) by a double beam method. As such laminated bodies are smaller in haze value, the laminated bodies are better in transparency. The results are shown in Table 3.

### [Optical Property Measurement]

A measuring instrument (KOBRA-WR, manufactured by a company, Oji Scientific Instruments) was used to measure the orientation direction of the polymerized polymerizable liquid crystal compound contained in each of the laminated bodies (1) to (3) and (H1). The measurement was made while the incident angle of light into the sample of the laminated body was varied. In this way, it was checked whether or not its liquid crystal was vertically oriented.

### [Weight Change Measurement]

The laminated bodies (1) to (3) and (H1) were put into a ventilation drying machine (FC410, manufactured by Advantec Toyo Kaisha, Ltd.) heated to 100° C., and then dried for 1 minute. About each of the laminated bodies, the following was calculated: the rate of a change in the weight before and after the laminated body was put therein {(“weight before the putting-in”−“weight after the putting-in”)/“weight before the putting-in”×100}. The results are shown in Table 3.

TABLE 3

| | | Haze | | |
|---|---|---|---|---|
| | Laminated | value | | Weight change |
| | body | (%) | Orientation | rate (%) |
| Example 1 | (1) | 0.19 | Vertical | 0.05 |
| | | | orientation | |
| Example 2 | (2) | 0.18 | Vertical | 0.02 |
| | | | orientation | |
| Example 3 | (3) | 0.11 | Vertical | 0.01 |
| | | | orientation | |
| Comparative | (H1) | 0.82 | Vertical | 0.03 |
| Example 1 | | | orientation | |

The laminated bodies of Examples 1 to 3 were excellent in transparency.

According to the optically-anisotropic-layer-forming composition of the present invention, an optically anisotropic film high in transparency can be produced.

1. An optically-anisotropic-layer-forming composition, comprising a polymerizable liquid crystal compound, a photopolymerization initiator, and a solvent (1) that is a lactone solvent having a boiling point of 200° C. or higher.

2. The composition according to claim 1, further comprising a solvent (2) different from the solvent (1).

3. The composition according to claim 2, wherein the content by percentage of the solvent (1) is from 1 to 70% by mass of the total of the solvents (1) and (2).

4. The composition according to claim 1, wherein the solvent (1) is at least one selected from the group consisting of γ-butyrolactone, γ-valerolactone, and δ-valerolactone.

5. The composition according to claim 1, further comprising a compound having an isocyanate group.

6. An optically anisotropic film which is obtained by applying the composition recited in claim 1 onto the outer surface of an oriented film laid over a surface of a substrate, and polymerizing the polymerizable liquid crystal compound contained in the composition.

7. A laminated body, comprising a substrate, an oriented film, and the optically anisotropic film recited in claim 6 in the three-member described order.

8. The laminated body according to claim 7, wherein the substrate comprises a polyolefin.

9. The laminated body according to claim 7 wherein the optically anisotropic film is a retardation film.

10. The laminated body according to claim 7, wherein the polymerizable liquid crystal compound is oriented vertically to the surface of the substrate.

11. The laminated body according to claim 7, the rate of a change in the weight of the body being 10% or less before and after the body is heated.

12. The laminated body according to claim 7, which is used for an in-plane switching (IPS) liquid crystal display device.

13. A method for producing a laminated body, comprising:
applying the composition recited in claim 1 onto the outer surface of an oriented film of an oriented-film-attached substrate, drying the resultant workpiece, and radiating light onto the dried workpiece.

14. A polarizing plate, comprising the laminated body recited in claim 7.

15. A display device, comprising the laminated body recited in claim 7.
